(19) United States
(12) Patent Application Publication
(10) Pub. No.: US 2015/0109115 A1
(43) Pub. Date: Apr. 23, 2015

(54) ACOUSTIC WARNING DEVICE AND MOTOR VEHICLE WITH AN ACOUSTIC WARNING DEVICE

(71) Applicant: GM Global Technology Operations LLC, Detroit, MI (US)

(72) Inventors: Peter Bender, Nierstein (DE); Oliver Jung, Griesheim (DE)

(21) Appl. No.: 14/518,917

(22) Filed: Oct. 20, 2014

(30) Foreign Application Priority Data
Oct. 19, 2013 (DE) 202013009278.5

(51) Int. Cl. B60Q 5/00

(52) U.S. Cl. CPC B60Q 5/005
USPC 340/425.5

(57) ABSTRACT

An acoustic warning device for a vehicle is disclosed. The acoustic warning device includes an air suction device having a suction tube, and a filter housing having a filter and a sound generating device which is arranged therein. The sound generating device is arranged between suction tube and filter with respect to a flow direction of the air. The sound generating device firstly emits the acoustic signal into a spatial volume of the filter housing. An additional chamber volume serves as a band-pass filter for the sound waves emitted from the sound generating device. The acoustic warning device may further include a sound source arranged outside the filter housing to generate sound signals with higher frequencies than emitted from the filter housing. By the combination of these two sound generating devices, an efficient emission of low-frequency and also of high-frequency sound signals is therefore possible.

### CROSS REFERENCE TO RELATED APPLICATION

This application claims priority to German Patent Application No. 202013009278.5 filed Oct. 19, 2013, which is incorporated herein by reference in its entirety.

### TECHNICAL FIELD

The technical field relates to an acoustic warning device and a motor vehicle with an acoustic warning device.

### BACKGROUND

Owing to their relatively low-noise electric drive, electric vehicles generate little or no driving noises. Therefore, the danger exists that an electric vehicle can approach a person without being perceived acoustically by this person. If this person whom such an electric vehicle is approaching is distracted, or the vehicle is not situated in the field of vision of the person, such a vehicle can only be noticed very late or even not noticed at all.

Therefore, electric vehicles may be additionally equipped with an acoustic warning device. This acoustic warning device is also known as a Pedestrian Friendly Alert System (PFA or respectively PFAF). In this connection, the vehicle is equipped with a sound source which emits a simulated driving noise when the vehicle is moving.

Conventionally, commercially available loudspeakers are used for emitting these simulated driving noises. These loudspeakers have a more or less intensively directed directional characteristic. This leads to the simulated driving noise being able to be perceived with a sufficient sound intensity only at particular regions outside the vehicle. In order to emit the artificially generated driving noise completely in all directions, in particular also the region behind a vehicle, with a sufficient sound intensity, several loudspeakers are therefore necessary.

German patent application DE 102009027911 A1 discloses a system for warning at least one person in an environment of a motor vehicle, in particular of an electric vehicle or of a hybrid vehicle, including at least one generator for generating an audio signal, a device for switching the generator on and off and/or for controlling the sound intensity of the audio signal.

With the emission of sound by means of a loudspeaker, the entire frequency spectrum within which the loudspeaker can emit its sound efficiently is determined by the size of the loudspeaker, in particular by the size of the loudspeaker membrane. For the emission of low frequencies, a relatively large loudspeaker is therefore required.

### SUMMARY

Against this background, the present disclosure addresses the problem of indicating an acoustic warning device which can be constructed simply and at a favorable cost. In accordance with the present disclosure, Accordingly, an acoustic warning device for a vehicle, in particular a person warning device, with an air suction device which includes a suction tube and a filter housing, and with a sound generating device which is arranged in the filter housing. The present disclosure also provides a motor vehicle, in particular a hybrid vehicle or electric vehicle with a range extender, which has an acoustic warning device according to the present disclosure.

The idea forming the basis of one aspect of the present disclosure includes the use of a volume of the filter housing, and the suction tube of an air suction device, as resonance elements for sound with low frequencies. The knowledge forming the basis of one aspect of the present disclosure follows that that the suction tube and the filter housing of an air suction device are not required for the suction of air of an internal combustion engine during a noiseless travel of an electrically driven vehicle. Therefore, in this operating mode, these components can be used as resonance elements of the acoustic warning device.

For this, according to one aspect, the present disclosure creates an acoustic warning device for a vehicle, in particular for a hybrid vehicle and/or an electric vehicle with a range extender. The vehicles normally have an internal combustion engine, for the operation of which air is suctioned and filtered via an air suction device. As long as the internal combustion engine is in operation, sufficient acoustic signals are emitted from the vehicle, which draw a pedestrian's attention to the vehicle. If, on the other hand, the internal combustion engine is not in operation, the vehicle can travel almost noiselessly. Therefore, in this operating mode, an acoustic warning signal must be emitted, for which the components of the air suction device which are not required in this operating mode are well suited.

So that such an acoustic warning signal is perceived as agreeable by a pedestrian, it is advantageous that the acoustic warning signal also emits sound signals with low frequency components. For this, a sound emission by means of a suitable resonance arrangement is advantageous. In this way, it is possible to also emit low-frequency sound with a sufficient level by a relatively small, light and economically priced loudspeaker. As low-frequency sound waves can only be located with great difficulty by the human ear, the position of the air suction device only plays a minor role.

In an embodiment, the sound generating device is designed to emit sound with a predetermined frequency spectrum. Such a predetermined frequency spectrum may have only a signal of a single predetermined frequency. These frequencies can either be emitted simultaneously or in succession in a tone sequence here by the acoustic warning device. Complex acoustic signals, which imitate for example a noise of an internal combustion engine, or other acoustic signals which draw the attention of a pedestrian, are also possible.

In an embodiment, the predetermined frequency spectrum lies in the range between 50 Hz and 5 kHz, preferably between 100 Hz and 3 kHz. Here, in particular very low frequencies are emitted particularly well to the environment by the arrangement according to the present disclosure.

In an embodiment, the suction tube has a length which is coordinated to the predetermined frequency spectrum. By the adapting of the length of the suction tube to the acoustic signals which are to be emitted and the frequency thereof, a particularly efficient and effective emission of acoustic warning signals can be achieved. Therefore, a readily perceptible acoustic signal can still be provided even with a relatively low emission level of the sound generating device.

In an embodiment, the air suction device has a filter which is arranged in the filter housing, and wherein the sound generating device is arranged between suction tube and filter with respect to a flow direction of the air. Through the arrangement of the sound generating device between suction tube and filter, the sound generating device firstly emits the acoustic signal into a spatial volume of the filter housing. A rearward additional chamber volume serves here as a band-pass filter for the sound waves emitted from the sound generating device.

In an embodiment, the acoustic warning device further includes at least one further sound source, which is arranged outside the filter housing. Through this further sound source outside the filter housing, preferably sound signals with higher frequencies can be emitted here. By the combination of these two sound generating devices, an efficient emission of low-frequency and also of high-frequency sound signals is therefore possible.

According to a further aspect, the present disclosure provides in addition a motor vehicle, in particular a hybrid vehicle or an electric vehicle with a range extender, which has an acoustic warning device according to the present disclosure.

In an embodiment, the air suction device is the air suction device of an internal combustion engine. In this way, this air suction device of the vehicle, which is necessary in any case, can be used so that an efficient sound emission is possible without additional components.

In an embodiment, the internal combustion engine is switched off during the sound emission by the sound generating deice. As long as the internal combustion engine is active, the internal combustion engine emits operating noises with a sufficient level, which is able to attract the attention to it of pedestrians in the environment. If, on the other hand, the internal combustion engine is switched off, no operating noises are emitted. Therefore, in this case, the emission of simulated noises by the acoustic warning device is necessary. As in this case no air has to be suctioned for the operation of the internal combustion engine, the air suction device of the internal combustion engine is available as a resonance element. In particular, the suction tube can be used here as bass reflex channel.

The above embodiments and further developments can be combined in any desired manner with one another, in so far as is expedient. Further possible embodiments, further developments and implementations of the present disclosure also include combinations, not mentioned explicitly, of features of the present disclosure described above or in the following with respect to the example embodiments. In particular, the specialist in the art will also add individual aspects here as improvements or supplements to the respective basic form of the present disclosure.

### BRIEF DESCRIPTION OF THE DRAWINGS

The present disclosure will hereinafter be described in conjunction with the following drawing figures, wherein like numerals denote like elements.

FIG. 1 shows a diagrammatic sectional view through an acoustic warning device according to an embodiment; and

FIG. 2 shows a diagrammatic illustration of a vehicle with an acoustic warning device according to an embodiment.

### DETAILED DESCRIPTION

The figures of the drawings are intended to convey a further understanding of the embodiments of the present disclosure. They show embodiments and serve in connection with the description for the explanation of principles and concepts of the present disclosure. Other embodiments and several of the named advantages will emerge with regard to the drawings. The elements of the drawings are not necessarily shown true to scale with respect to one another. In the figures of the drawings, identical, functionally identical elements, features and components and elements features and components having the same effect—in so far as not stated otherwise—are respectively given the same reference numbers.

The following detailed description is merely exemplary in nature and is not intended to limit the present disclosure or the application and uses of the present disclosure. Furthermore, there is no intention to be bound by any theory presented in the preceding background or the following detailed description.

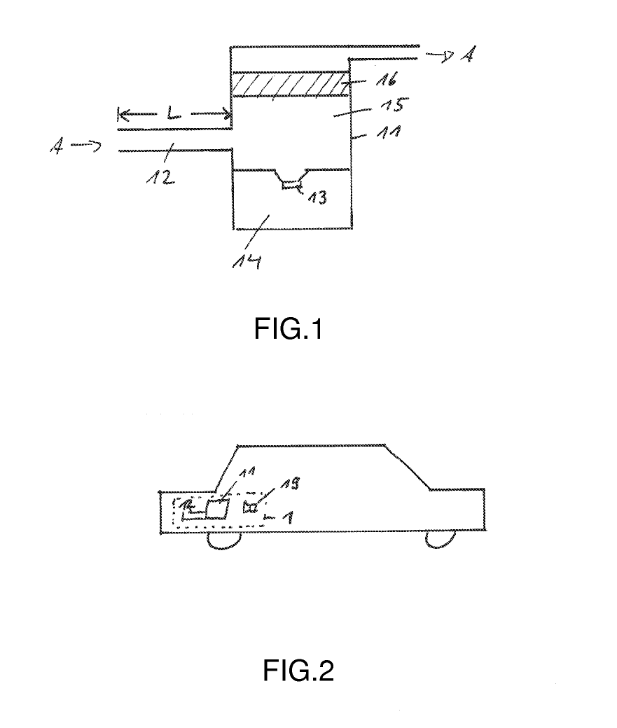

FIG. 1 shows a schematic illustration of a sectional view through an acoustic warning device 1 according to an embodiment. The acoustic warning device 1 includes an air suction device with a suction tube 12 and a filter housing 11. The suction tube 12 is connected here with the filter housing 11. In addition, a sound generating device 13 is arranged in the filter housing 11.

The air suction device further includes an air filter 16. The air suction device can be flowed through by air by a stream of air in the direction of the arrows A. The air flows here in the direction of the arrows A from the environment through the suction tube 12 into the filter housing 11. In the filter housing 11, the air flows through the air filter 16 and subsequently leaves the filter housing 11.

During the operation of the acoustic warning device 1, the air suction device is not, however, flowed through by air. The sound generating device 13 is arranged here in the filter housing 11 so that the emission side of the sound generating device 13 emits into a spatial region 15 in which the suction tube 12 is connected with the filter housing 11. The sound generating device 13 is arranged within the filter housing 11 so that a side of the sound generating device 13 lying opposite the sound-emitting side forms a closed spatial region 14 with the surrounding space. If applicable, a separate housing (not illustrated) can be arranged for this around this side of the sound generating device 13.

The spatial region 15, into which the sound generating device 13 emits its sound, forms here a volume, the dimensions of which are coordinated to the frequency spectrum of the sound which is to be emitted by the acoustic warning device 1. In this way, through the spatial regions 14, 15 and the spatial region of the suction tube a filtering effect can be achieved for the frequencies which are to be emitted. The frequency spectrum to be emitted by the acoustic warning device 1 can therefore be adapted by corresponding design of the filter housing 11, in particular of the spatial region 14. Furthermore, the low-frequency sound emitted by the sound generating device 13 is directed into the environment through the suction tube 12. The suction tube 12 served here as reflection element.

The length L of the suction tube 12 is adapted here to the frequency spectrum which is to be emitted by the acoustic warning device 1. Preferably, the length L of the suction tube 12 has a length corresponding to the wavelength of the frequencies which are to be emitted.

If sound waves with predetermined frequencies are emitted through the sound generating device 13, the volume of the filter housing 1, in particular the spatial region 15 in front of the sound generating device 13 and also the spatial region 14 behind the sound generating device 13 can be coordinated here to these predetermined frequencies. Likewise, the length L of the suction tube 12 can be adapted to the wavelength of these predetermined frequencies. In this way, a particularly efficient sound emission is possible by means of a relatively small and favorably priced loudspeaker as sound generating device 13.

FIG. 2 shows a schematic illustration of a motor vehicle 2 with an acoustic warning device 1 according to an embodiment. Such a motor vehicle 2 can be, for example, a hybrid vehicle or an electric vehicle with a range extender. Such vehicles, owing to their existing internal combustion engine, also have an air suction device with a suction tube 12 and a filter housing 11.

As long as this internal combustion engine is not active and the vehicle travels solely under electrically-driven power, the suction tube 12 and the filter housing 11 can be used as resonance elements for the emission of sound.

As presently preferred low-frequency sound waves can be emitted particularly well through an acoustic warning device with a sound generating device within the filter housing 11, a further sound generating device 19 can be arranged outside the air suction device. Such a further sound generating device 19 can then preferably emit sound waves with higher frequencies. Through such a combination of two sound generating devices 13 and 19 therefore an efficient sound emission plate in a broad frequency spectrum is possible.

Preferably, the frequency spectrum of the sound waves emitted by the acoustic warning device lies in the range between 50 Hz and 5 kHz. Particularly preferably, the frequency spectrum lies in the range between 100 Hz and 3 kHz. Here, preferably signals in the frequency range between 50 Hz and 250 Hz are emitted by the sound generating device within the filter housing 11, whilst the higher frequency signal components are preferably emitted by the further sound generating device 19.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-9. (canceled)

10. An acoustic warning device for a vehicle comprising:
an air suction device having a suction tube coupled to a filter housing; and
a sound generating source arranged in the filter housing and configured to emit a warning signal therefrom.

11. The acoustic warning device according to claim 10, wherein the sound generating source is configured to emit the warning signal within a predetermined frequency spectrum.

12. The acoustic warning device according to claim 11, wherein the predetermined frequency spectrum is in the range between 50 Hz and 5 kHz

13. The acoustic warning device according to claim 11, wherein the predetermined frequency spectrum is in the range between 100 Hz and 3 kHz.

14. The acoustic warning device according to claim 11, wherein the suction tube has a length which is coordinated to the predetermined frequency spectrum.

15. The acoustic warning device according to claim 14, wherein the suction tube length is coordinated to the wavelength of a fundamental frequency within the predetermined frequency spectrum.

16. The acoustic warning device according to claim 10, wherein the air suction device further comprises a filter arranged in the filter housing such that the sound generating device is arranged between suction tube and the filter with respect to a flow direction.

17. The acoustic warning device according to claim 10, further comprising an external sound source arranged outside the filter housing and configured to emit the warning signal therefrom.

18. The acoustic warning device according to claim 17, wherein the sound generating source is configured to emit the warning signal within a first predetermined frequency spectrum and the external sound source is configured to emit the warning signal within a second predetermined frequency spectrum which is higher than the first predetermined frequency spectrum.

19. The acoustic warning device according to claim 10, further comprising a switch configured enable the acoustic warning device for emitting the warning signal when the internal combustion engine when is switched off, and configured to disable the acoustic warning device when the internal combustion engine is switched on.

20. A motor vehicle with a range extender and further comprising an acoustic warning device according to claim 10.

21. The motor vehicle according to claim 19, wherein the air suction device comprises an air intake device of an internal combustion engine.

22. The motor vehicle according to claim 20, further comprises a switch configured enable the acoustic warning device for emitting the warning signal when the internal combustion engine when is switched off, and configured to disable the acoustic warning device when the internal combustion engine is switched on.
